(19) United States
(12) Patent Application Publication
(10) Pub. No.: US 2016/0167542 A1
(43) Pub. Date: Jun. 16, 2016

(54) APPARATUS AND METHOD FOR CONTROLLING VEHICLE

(71) Applicant: HANWHA TECHWIN CO.,LTD., Changwon-si (KR)

(72) Inventor: Wongun KIM, Changwon-si (KR)

(73) Assignee: Hanwha Techwin Co., Ltd., Changwon-Si (KR)

(21) Appl. No.: 14/690,779

(22) Filed: Apr. 20, 2015

(30) Foreign Application Priority Data
Dec. 15, 2014 (KR) 10-2014-0180492

(51) Int. Cl. B60L 11/18; G01C 21/34; G01S 19/13

(52) U.S. Cl. CPC B60L 11/1862; G01S 19/13; G01C 21/3469

(57) ABSTRACT

There is provided a vehicle controlling apparatus. The vehicle controlling apparatus includes a communicator configured to receive at least one of preceding vehicle information provided by a preceding vehicle; an inputter configured to receive a user input with respect to a path or a power control mode; and a controller configured to generate power profile information based on the preceding vehicle information when the preceding vehicle information is received and configured to generate a dynamic power control signal for driving a power source of a vehicle based on the power profile information.

### CROSS-REFERENCE TO RELATED APPLICATION

This application claims priority from Korean Patent Application No. 10-2014-0180492, filed on Dec. 15, 2014, in the Korean Intellectual Property Office, the disclosure of which is incorporated herein by reference in its entirety.

### BACKGROUND

1. Field

Apparatuses and methods consistent with exemplary embodiments relate to controlling a vehicle.

2. Description of the Related Art

An environment-friendly vehicle includes at least one motor and an engine and uses driving force of the motor. The environment-friendly vehicle may include, for example, a fuel battery vehicle, an electric vehicle, and a plug-in electric vehicle.

In the environment-friendly vehicle, in order to efficiently use a battery, a method of controlling a state of charge (SOC) of the battery by using a driving pattern to which various driving environments are reflected may be used.

Because road state information, position information, and previous driving information of a vehicle are used in order to grasp a driving state in accordance with a path, it may be difficult for an environment-friendly vehicle controlling apparatus to correctly determine a current driving state. When it is difficult for the environment-friendly vehicle controlling apparatus to correctly determine the current driving state, improving the fuel efficiency may be difficult.

### SUMMARY

One or more exemplary embodiments include an apparatus and a method for controlling a vehicle with improved fuel efficiency.

According to an aspect of an exemplary embodiment, there is provided a vehicle controlling apparatus including a communicator for receiving at least one of preceding vehicle information provided by a preceding vehicle, an inputter for receiving a user input with respect to a path, and a controller for generating power profile information based on the preceding vehicle information when the preceding vehicle information is received and generating a dynamic power control signal for driving a power source of a vehicle based on the power profile information.

When the preceding vehicle information is driving load information of the preceding vehicle, the controller generates power profile information corresponding to the driving load information and the power profile information represents power state information with the lapse of time.

The driving load information may include at least one of motor output information and engine output information, the motor output information may represent information on load power that is output from a motor of the preceding vehicle in accordance with driving of the preceding vehicle, and the engine output information may represent information on torque and revolutions per minute (rpm), which is output from an engine of the preceding vehicle in accordance with driving of the preceding vehicle.

The power profile information corresponding to the driving load information may be the same as at least one of the motor output information and the engine output information of the preceding vehicle.

When the preceding vehicle information is speed information of the preceding vehicle, the controller may generate power profile information based on the speed information.

The controller may generate the power profile information by extracting altitude information from global positioning system (GPS) information, calculating a slope of the path by using the altitude information, calculating a speed profile of the path based on the speed information, and calculating a power profile from the slope and the speed profile, and the speed profile may represent a speed with the lapse of time.

The vehicle controlling apparatus may further include a memory for storing previous driving information, the controller may generate power profile information based on the previous driving information when the preceding vehicle information is not received and may generate a basic power control signal based on the power profile information.

The controller may generate the dynamic power control signal by defining a state of charge (SOC) of a battery as a state variable based on the power profile information and minimizing a performance index so as to maximize energy efficiency.

The communicator may receive preceding vehicle information by section whenever a vehicle reaches a predetermined point of the path.

The path represents a bus route and, whenever a bus stops at a bus stop of the bus route, the communicator may receive preceding vehicle information of the preceding bus on a section between the bus stop at which the bus stops and a next bus stop from the preceding bus that runs along the bus route.

According to an aspect of another exemplary embodiment, there is provided a vehicle controlling method including receiving a user input with respect to a path, determining whether preceding vehicle information is received, generating power profile information based on the preceding vehicle information when the preceding vehicle information is received, and generating a dynamic power control signal for driving a power source of a vehicle based on the power profile information.

When the preceding vehicle information is driving load information of a preceding vehicle, the power profile information may be power profile information corresponding to the driving load information and may represent power state information with the lapse of time.

The driving load information may include at least one of motor output information and engine output information, the motor output information may represent information on load power that is output from a motor of the preceding vehicle in accordance with driving of the preceding vehicle, and the engine output information may represent information on torque and rpm, which is output from an engine of the preceding vehicle in accordance with driving of the preceding vehicle.

The power profile information corresponding to the driving load information may be the same as at least one of the motor output information and the engine output information of the preceding vehicle.

When the preceding vehicle information is speed information of the preceding vehicle, the power profile information may be generated based on the speed information.

The generating of the power profile information may include receiving GPS information, extracting altitude information from the GPS information, calculating a slope of the path by using the altitude information, calculating a speed profile of the path based on the speed information, and calculating a power profile from the slope and the speed profile, and the speed profile may represent a speed with the lapse of time.

The vehicle controlling method may further include storing previous driving information, generating power profile information based on the previous driving information when the preceding vehicle information is not received, and generating a basic power control signal based on the power profile information.

In the generating of the dynamic power control signal, the dynamic power control signal may be generated by defining an SOC of a battery as a state variable based on the power profile information and minimizing a performance index so as to maximize energy efficiency.

In the determining whether the preceding vehicle information is received, it may be determined whether preceding vehicle information by section is received whenever a vehicle reaches a predetermined point of the path.

The path may represent a bus route and, in the determining whether the preceding vehicle information is received, whenever a bus stops at a bus stop of the bus route, preceding vehicle information of the preceding bus on a section between the bus stop at which the bus stops and a next bus stop may be received from the preceding bus that runs along the bus route.

According to an aspect of another exemplary embodiment, there is provided a vehicle controlling method including a communicator configured to receive preceding vehicle information provided by a preceding vehicle; an inputter configured to receive a user input with respect to a path or a power control mode; and a controller configured to generate power profile information based on the preceding vehicle information in response to the preceding vehicle information being received and configured to generate a dynamic power control signal for driving a power source of a vehicle based on the power profile information.

When the preceding vehicle information is driving load information of the preceding vehicle, the controller may be configured to generate power profile information corresponding to the driving load information, and wherein the power profile information comprises power state information with respect to time.

The driving load information may include at least one of motor output information and engine output information, wherein the motor output information includes information on load power output from a motor of the preceding vehicle in accordance with driving of the preceding vehicle, and wherein the engine output information comprises information on torque and revolutions per minute (rpm), which is output from an engine of the preceding vehicle in accordance with driving of the preceding vehicle.

The power profile information corresponding to the driving load information may be the same as at least one of the motor output information and the engine output information of the preceding vehicle.

When the preceding vehicle information is speed information of the preceding vehicle, the controller may be configured to generate power profile information based on the speed information.

The controller may be configured to generate the power profile information by extracting altitude information from global positioning system (GPS) information, calculating a slope of the path by using the altitude information, calculating a speed profile of the path based on the speed information, and calculating a power profile from the slope and the speed profile, and wherein the speed profile may include a speed with respect to time.

The vehicle controlling apparatus may further include a memory configured to store previous driving information, wherein the controller may be configured to generate power profile information based on the previous driving information when the preceding vehicle information is not received and is configured to generate a basic power control signal based on the power profile information.

The controller may be configured to generate the dynamic power control signal by defining a state of charge (SOC) of a battery corresponding to a state variable based on the power profile information and is configured to minimize a performance index and maximize energy efficiency.

The communicator may be configured to receive preceding vehicle information by section in response to a vehicle reaching a predetermined point of the path.

The path may include a bus route, and wherein, in response to a bus stopping at a bus stop of the bus route, the communicator is configured to receive preceding vehicle information of a preceding bus on a section between the bus stop at which the bus stops and a next bus stop from the preceding bus that runs along the bus route.

Additional aspects will be set forth in part in the description which follows and, in part, will be apparent from the description, or may be learned by practice of the presented embodiments.

According to the exemplary embodiments, it is possible to provide an apparatus and a method for controlling a vehicle with improved fuel efficiency.

### BRIEF DESCRIPTION OF THE DRAWINGS

The above and/or other aspects will become apparent and more readily appreciated from the following description of exemplary embodiments, taken in conjunction with the accompanying drawings in which:

FIG. 1 is a block diagram illustrating a configuration of a vehicle controlling apparatus according to an exemplary embodiment;

FIG. 2 is a flowchart illustrating a vehicle controlling method according to an exemplary embodiment;

FIGS. 3A and 3B are views illustrating a dynamic power control signal according to an exemplary embodiment;

FIG. 4 is a view illustrating a power profile generating method according to an exemplary embodiment; and

FIGS. 5A and 5B are views illustrating a vehicle controlling method according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description.

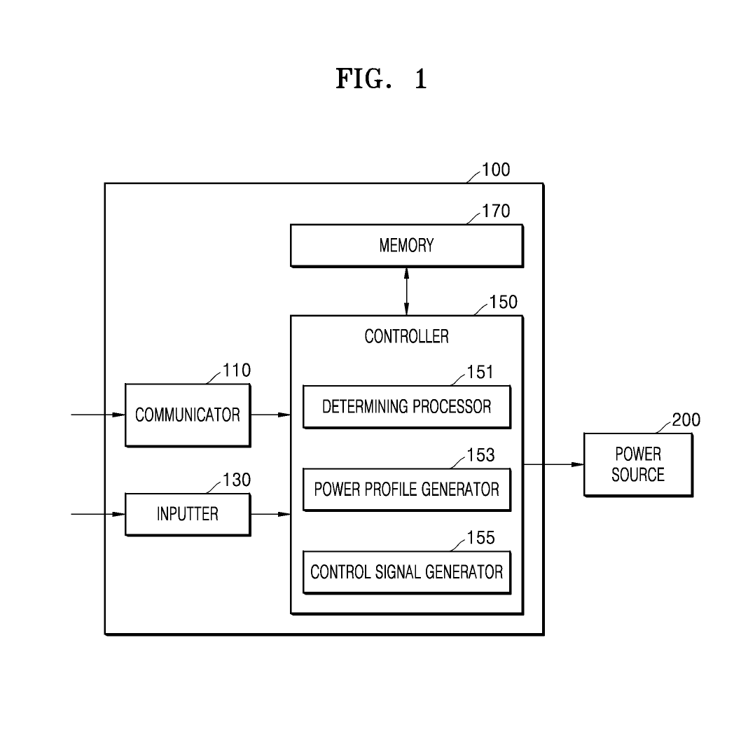

FIG. 1 is a block diagram illustrating a configuration of a vehicle controlling apparatus 100 according to an exemplary embodiment.

Referring to FIG. 1, the vehicle controlling apparatus 100 according to the exemplary embodiment includes a communicator 110, an inputter 130, a controller 150, and a memory 170.

The communicator 110 performs communications between a vehicle to be controlled and the outside.

The vehicle to be controlled may be an electric vehicle (EV), a foldable electric vehicle (FEV), a hybrid electric vehicle (HEV), or a plug-in hybrid electric vehicle (PHEV).

Each of the EV and the FEV includes a motor driven by electricity.

Each of the HEV and the PHEV includes two or more separate power sources. The HEV that uses an engine and a motor as power sources may be divided into a serial type HEV and a parallel type HEV in accordance with a method of using the engine and the motor. The serial-type HEV uses the motor as the power source and drives the engine in order to drive the motor so that electric energy may be stored in a battery. The parallel type HEV may use both the engine and the motor as the power sources.

The communicator 110 may receive at least one of global positioning system (GPS) information transmitted from a satellite and preceding vehicle information provided by a preceding vehicle. However, the inventive concept is not limited thereto.

The GPS information may include at least one of position information and altitude information.

The preceding vehicle information may include at least one of driving load information and speed information of the preceding vehicle. However, the inventive concept is not limited thereto.

The driving load information of the preceding vehicle may include at least one of motor output information and engine output information in accordance with driving of the preceding vehicle. The motor output information may mean information on load power output from the motor. The engine output information may mean information on torque and revolutions per minute (rpm) supplied by the engine and transmission.

For example, the driving load information of the EV is the motor output information, the driving load information of the serial type HEV is the motor output information, and the driving load information of the parallel type HEV is the engine output information and the motor output information.

The driving load information of the preceding vehicle may be estimated from the speed information of the preceding vehicle.

The speed information of the preceding vehicle may be transmitted from the preceding vehicle and may be sensed by the vehicle to be controlled. However, the inventive concept is not limited thereto.

The communicator 110 may receive the preceding vehicle information along a path at least once.

The communicator 110 according to an exemplary embodiment may receive the preceding vehicle information on the entire path. For example, the communicator 110 of a bus that runs along a route may receive the preceding vehicle information on the entire path from a preceding bus that finish running along the same route.

The communicator 110 according to an exemplary embodiment may receive the preceding vehicle information by section. For example, the communicator 110 of a following bus may receive the preceding vehicle information on a section between bus stops from a preceding bus that runs along the same route.

The communicator 110 may receive the preceding vehicle information whenever the bus reaches a predetermined point of a path. For example, the communicator 110 of the following bus may receive the preceding vehicle information on a section between a corresponding bus stop and a next bus stop from the preceding bus that runs along the same route whenever the bus stops at a bus stop.

The inputter 130 receives an input of a user. The inputter 130 may be formed of a button, a switch, and a touch pad. However, the inventive concept is not limited thereto. The inputter 130 may receive at least one of a user input with respect to a path and a user input with respect to a power control mode.

The user input with respect to the path may include at least one of a user input for selecting a starting point, a user input for selecting a destination, and a user input for selecting one of a plurality of paths with the same starting point and destination.

The user input with respect to the power control mode may be a user input for selecting at least one of a first dynamic power control mode in accordance with driving load information of a preceding vehicle, a second dynamic power control mode in accordance with speed information of the preceding vehicle, and a basic power control mode that is not related to the preceding vehicle information (in accordance with previous driving information of a vehicle to be controlled). However, the inventive concept is not limited thereto.

The controller 150 includes a determining processor 151, a power profile generator 153, and a control signal generator 155. The controller 150 generates a power control signal based on information received from at least one of the communicator 110 and the inputter 130. The controller 150 extracts information required for generating the power control signal from the memory 170. The controller 150 transmits the generated power control signal to a power source 200.

The controller 150 may be connected to at least one of the communicator 110, the inputter 130, the memory 170, and the power source 200 through a controller area network (CAN) communication. However, the inventive concept is not limited thereto.

The controller 150 may extract geographical information such as the position information and the altitude information from the GPS information.

The determining processor 151 determines whether the GPS information and the user input with respect to the path may be received and determines the power control mode. The determining processor 151 determines whether the GPS information and the user input with respect to the path are received and may determine the power control mode.

The determining processor 151 determines the power control mode in accordance with whether the preceding vehicle information may be received. The determining processor 151 may determine the power control mode in accordance with whether the preceding vehicle information is received.

For example, the determining processor 151 executes the first dynamic power control mode when the communicator 110 receives the driving load information of the preceding vehicle and executes the second dynamic power control mode when the communicator 110 receives the speed information of the preceding vehicle. The determining processor 151 executes the basic power control mode when the preceding vehicle information is not received through the communicator 110.

In another exemplary embodiment, the determining processor 151 executes the first dynamic power control mode when the driving load information of the preceding vehicle is received through the communicator 110 and executes the second dynamic power control mode when the speed information of the preceding vehicle is received through the communicator 110. The determining processor 151 executes the basic power control mode when the preceding vehicle information is not received after the GPS information and the user input with respect to the path are received.

The determining processor 151 may determine the power control mode in accordance with the user input with respect to the power control mode. For example, although the driving load information of the preceding vehicle is received, when the user input for selecting the basic power control mode is received, the determining processor 151 may execute the basic power control mode in accordance with the user input.

The power profile generator 153 generates power profile information in accordance with determination of the determining processor 151. The power profile information may correspond to power state information with respect to time (e.g., the lapse of time).

For example, when the first dynamic power control mode is executed in accordance with the determination of the determining processor 151, the power profile generator 153 may generate the power profile information corresponding to the driving load information of the preceding vehicle. The power profile information corresponding to the driving load information of the preceding vehicle may be the same as at least one of motor output information and engine output information in accordance with the driving of the preceding vehicle.

In another exemplary embodiment, when the second dynamic power control mode is executed in accordance with the determination of the determining processor 151, the power profile generator 153 may generate the power profile information based on the speed information of the preceding vehicle. The power profile generator 153 calculates a slope of the path by using path information and the GPS information, calculates a speed profile of the path by using the speed information of the preceding vehicle, and may calculate a power profile of the path from the slope of the path and the speed profile. The speed profile may mean the speed information with respect to time (e.g., the lapse of time).

In another exemplary embodiment, when the basic power control mode is executed in accordance with the determination of the determining processor 151, the power profile generator 153 may generate the power profile information based on previous driving information of a corresponding path, which is previously stored in the memory 170. The power profile generator 153 may determine the power profile information based on the previous driving information of the corresponding path.

The control signal generator 155 generates the power control signal for driving the power source 200.

For example, the control signal generator 155 may generate the power control signal based on the power profile information. For example, the control signal generator 155 defines a SOC of a battery as a state variable based on the power profile of the path, minimizes a performance index so as to maximize energy efficiency, and may generate an optimal power control signal for improving fuel efficiency. The control signal generator 155 may generate the dynamic power control signal by using an optimization algorithm such as dynamic programming.

The control signal generator 155 may generate a dynamic power control signal by section by using preceding vehicle information by section that is received whenever a vehicle reaches a predetermined point of a path. However, the inventive concept is not limited thereto.

According to the exemplary embodiments, the control signal generator 155 may rapidly and simply generate the dynamic power control signal by using the preceding vehicle information. Therefore, driving of a vehicle to be controlled may be correctly controlled by using the dynamic power control signal to which a real time driving state is reflected, and, as a result, fuel efficiency of the vehicle to be controlled may be improved.

In another exemplary embodiment, the control signal generator 155 may generate the basic power control signal by using the previous driving information that is stored in the memory 170.

According to the exemplary embodiments, the control signal generator 155 may generate the power control signal of the vehicle to be controlled by using the previous preceding information of the vehicle to be controlled when the preceding vehicle information is not used.

The controller 150 may control an operation of the power source 200 by transmitting the power control signal generated by the control signal generator 155 to the power source 200.

The power control signal may include a driving command and a braking command on a driving source. For example, the dynamic control signal may include a motor driving command or a motor braking command on an operation of a motor processor unit (MCU) for controlling a motor, an engine driving command or an engine braking command on an operation of an engine control unit (ECU) for controlling driving of an engine, a generator driving command or a generator braking command on an operation of a generator control unit (GCU) for controlling a target amount of generation of a generator, and a battery control command on an operation of a battery management system (BMS) for controlling a power generating function or an energy storage function of a battery.

The memory 170 may store the previous driving information. The previous driving information may be required for generating the basic power control signal as described above.

The power source 200 may include at least one of the engine and the motor.

The vehicle controlling apparatus 100 according to the exemplary embodiment may be a part of the vehicle to be controlled. However, the inventive concept is not limited thereto.

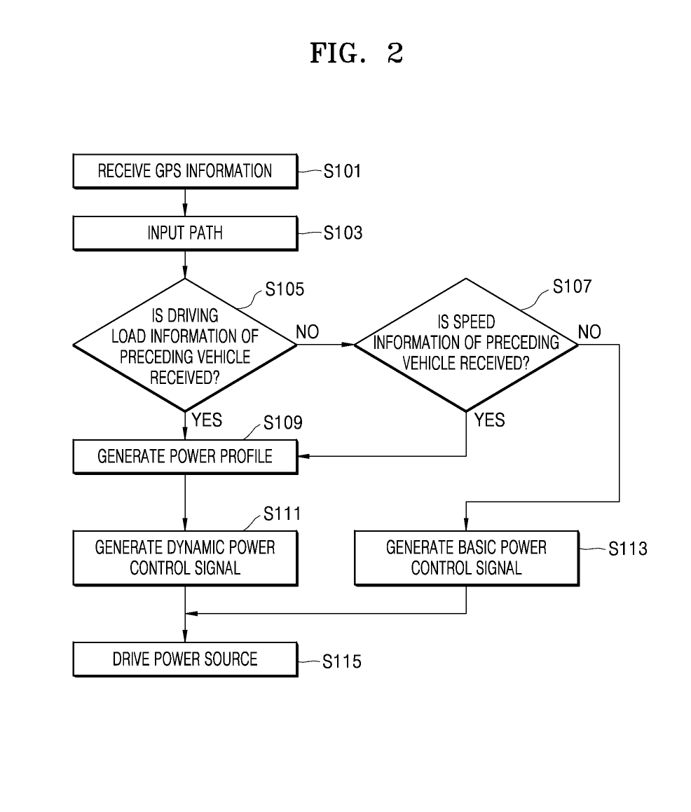

FIG. 2 is a flowchart illustrating a vehicle controlling method according to an exemplary embodiment.

Referring to FIG. 2, in a starting standby state of the vehicle to be controlled, when the communicator 110 receives the GPS information in operation S101 and the inputter 130 receives the user input with respect to the path in operation S103, the determining processor 151 determines whether the driving load information of the preceding vehicle is received in operation S105.

The determining processor 151 may previously determine whether the driving load information is received and may determine whether the speed information is received only when the driving load information is not received in determining whether the preceding vehicle information is received. However, the inventive concept is not limited thereto.

The power profile generator 153 generates the power profile information in accordance with the determination of the determining processor 151 in operation S109.

When the driving load information of the preceding vehicle is received through the communicator 110 in operation S105 and the determining processor 151 executes the first dynamic power control mode, the power profile generator 153 generates the power profile corresponding to the driving load information of the preceding vehicle in operation S109.

When the speed information of the preceding vehicle is received through the communicator 110 in operation S107 and the determining processor 151 executes the second dynamic power control mode, the power profile generator 153 generates the power profile corresponding to the speed information of the preceding vehicle in operation S109.

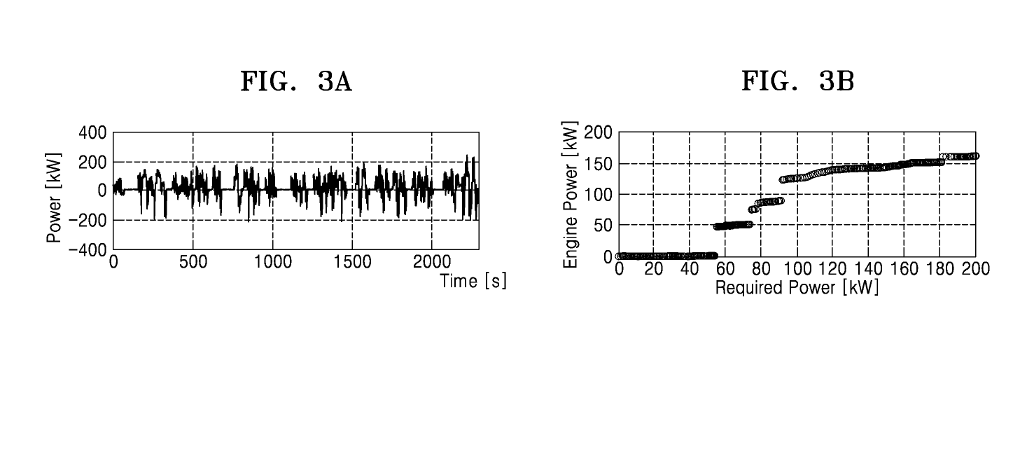

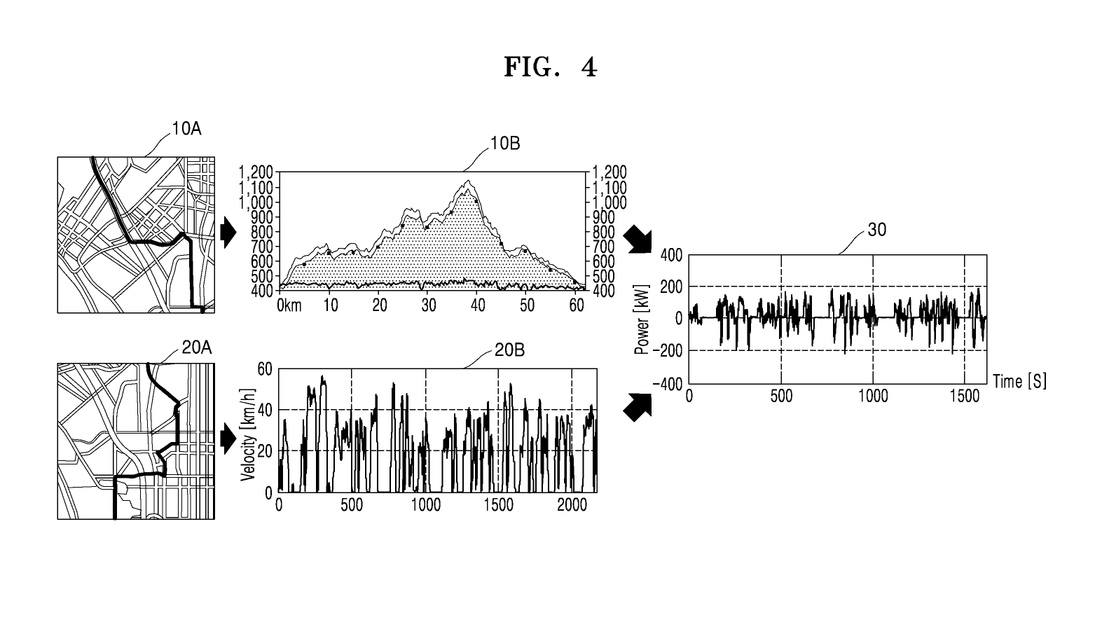

The control signal generator 155 generates the dynamic power control signal based on one of the power profile corresponding to the driving load information of the preceding vehicle or the speed information of the preceding vehicle in operation S111. Hereinafter, the power profile and the dynamic power control signal according to the exemplary embodiments will be described in detail with reference to FIGS. 3 and 4.

FIGS. 3A and 3B are views illustrating a dynamic power control signal according to an exemplary embodiment.

FIG. 3A illustrates driving load information received form a preceding vehicle of a vehicle to be controlled. The driving load information illustrated in FIG. 3A is power profile information of the preceding vehicle, which illustrates a state of power of the preceding vehicle with respect to time (e.g., the lapse of time). In FIG. 3A, the power profile generated by the power profile generator 153 is the same as the power profile of the preceding vehicle. The driving load information illustrated in FIG. 3A may be driving load information of an entire path or driving load information of a predetermined section of the path.

FIG. 3B illustrates the dynamic power control signal generated based on the power profile. The dynamic power control signal illustrated in FIG. 3B is power source output information of the vehicle to be controlled. The control signal generator 155 may generate the dynamic power control signal illustrated in FIG. 3B by applying dynamic programming to the power profile generated as illustrated in FIG. 3A. The dynamic power control signal illustrated in FIG. 3B may be a dynamic power control signal with respect to an entire path and a dynamic power control signal with respect to a predetermined section of the path.

FIG. 4 is a view illustrating a power profile generating method according to an exemplary embodiment.

Referring to FIG. 4, a map 10A illustrates a path in accordance with a user input. The power profile generator 153 obtains altitude information by using path information and position information extracted from GPS information and may calculate a slope of a path from the altitude information as illustrated in a map 20A.

An altitude graph 10B illustrates the altitude information received from a preceding vehicle. The power profile generator 153 may extract a speed profile from the speed information of the preceding vehicle of altitude graph 10B as illustrated in a speed graph 20B. The power profile generator 153 may calculate a power profile as illustrated in 30 by using the slope of the path of the map 20A and the speed profile of speed graph 20B. The power profile illustrated in 30 may be a power profile with respect to an entire path or a power profile with respect to a predetermined section of the path.

Although not shown in the drawing, the control signal generator 155 may generate the dynamic power control signal by applying the dynamic programming to the power profile generated as illustrated in 30.

Referring to FIG. 2 again, the control signal generator 155 generates a basic power control signal by using previous driving information in operation S113 when the driving load information of the preceding vehicle is not received in operation S105 and the speed information of the preceding vehicle is not also received in operation S107.

The controller 150 drives a power source based on the generated basic power control signal in operation S115. The vehicle controlling apparatus 100 according to an exemplary embodiment may improve fuel efficiency of the vehicle to be controlled by driving the power source based on the preceding vehicle information or the previous driving information.

The vehicle controlling apparatus 100 may perform the operations S105 to S115 on the entire path. The vehicle controlling apparatus 100 may perform the operations S105 to S115 whenever a vehicle reaches a predetermined point of a path.

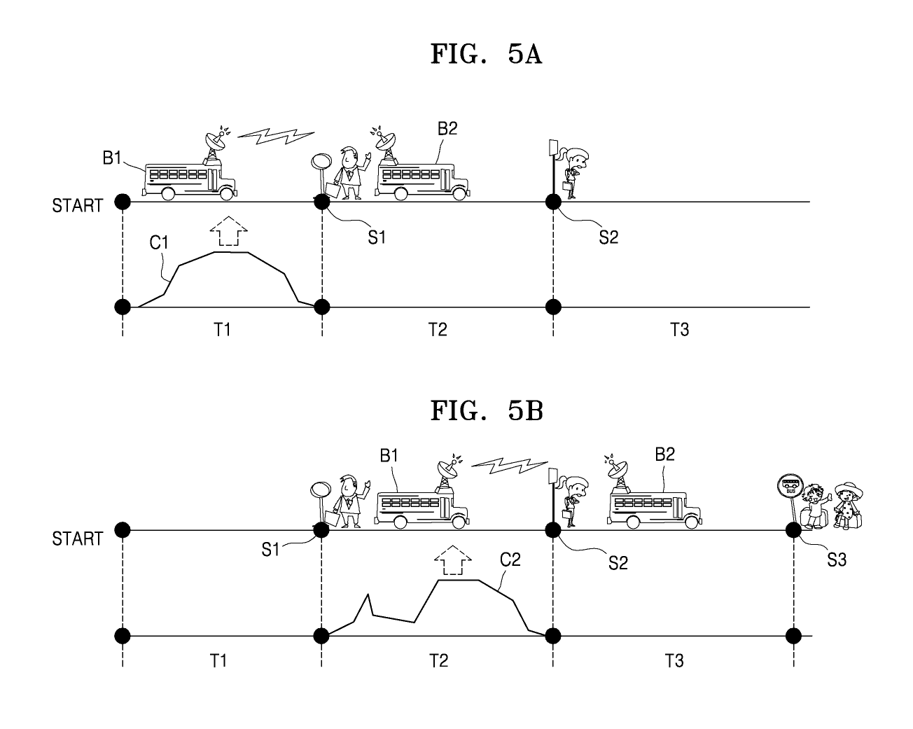

FIGS. 5A and 5B are views illustrating a vehicle controlling method according to an exemplary embodiment.

In FIG. 5, in a plurality of vehicles that runs along the same bus route, the vehicle controlling apparatus 100 of a first bus B1 according to the exemplary embodiment may use driving load information of a second bus B2 that is a preceding vehicle in order to control driving of the first bus B1. The vehicle controlling apparatus 100 may reflect a real time driving state to driving control of the first bus B1 by receiving the driving load information of the second bus B2 on a section between a bus stop at which the first bus B1 stops and a next bus stop whenever the first bus B1 stops at the bus stop or receiving the driving load information of the second bus B2 on a section between a bus stop at which the second bus B2 stops and a next bus stop whenever the second bus B2 stops at the bus stop.

Referring to FIG. 5A, the first bus B1 receives the driving load information in a first section T1 from the second bus B2 that is the preceding vehicle at a starting point START. The first section T1 may mean a section between the starting point START and a first bus stop S1. The first period T1 may mean a section in which the second bus B2 was driven immediately before the first bus B1 is driven.

The determining processor 151 of the vehicle controlling apparatus 100 for controlling power of the first bus B1 may execute the first dynamic power control mode when the driving load information in the first section T1 is received from the second bus B2. In the first dynamic power control mode, the power profile generator 153 generates a power profile C1 of the first bus B1 that is the same as the power profile of the second bus B2.

The control signal generator 155 may generate the dynamic power control signal by applying the dynamic programming to the power profile C1 of the first bus B1 generated by the power profile generator 153. The controller 150 may control driving of the power source 200 of the first bus B1 in the first section T1 in accordance with the dynamic power control signal. As a result, the first bus B1 may be driven in the first section T1 with optimized power.

Referring to FIG. 5B, the first bus B1 receives the driving load information in a second section T2 from the second bus B2 that is the preceding vehicle at the first bus stop S1. The second section T2 may mean a section between the first bus stop S1 and the second bus stop S2.

The vehicle controlling apparatus 100 for controlling the power of the first bus B1 may control the driving of the power source 200 of the first bus B1 in the second section T2 in the first dynamic power control mode as described above with reference to FIG. 5A. As a result, the first bus B1 may be driven in the second section T2 with optimized power.

It should be understood that the exemplary embodiments described therein should be considered in a descriptive sense only and not for purposes of limitation. Descriptions of features or aspects within each exemplary embodiment should typically be considered as available for other similar features or aspects in other embodiments.

At least one of the components, elements or units represented by a block as illustrated by reference numerals 100, 110, 130, 150 and 170 in FIG. 1 may be embodied as various numbers of hardware, software and/or firmware structures that execute respective functions described above, according to an exemplary embodiment. For example, at least one of these components, elements or units may use a direct circuit structure, such as a memory, processing, logic, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions. Also, at least one of these components, elements or units may further include a processor such as a central processing unit (CPU) that performs the respective functions, a microprocessor, or the like. Further, although a bus is not illustrated in the above block diagrams, communication between the components, elements or units may be performed through the bus. Functional aspects of the above exemplary embodiments may be implemented in algorithms that execute on one or more processors. Furthermore, the components, elements or units represented by a block or processing steps may employ any number of related art techniques for electronics configuration, signal processing and/or control, data processing and the like.

While exemplary embodiments have been particularly shown and described above, it will be understood by those of ordinary skill in the art that various changes in form and details may be made therein without departing from the spirit and scope of the inventive concept as defined by the following claims.

What is claimed is:

1. A vehicle controlling apparatus comprising:
a communicator configured to receive preceding vehicle information provided by a preceding vehicle;
an inputter configured to receive a user input with respect to a path or a power control mode; and
a controller configured to generate power profile information based on the preceding vehicle information in response to the preceding vehicle information being received and configured to generate a dynamic power control signal for driving a power source of a vehicle based on the power profile information.

2. The vehicle controlling apparatus of claim 1, wherein, when the preceding vehicle information is driving load information of the preceding vehicle, the controller is configured to generate power profile information corresponding to the driving load information, and
wherein the power profile information comprises power state information with respect to time.

3. The vehicle controlling apparatus of claim 2,
wherein the driving load information comprises at least one of motor output information and engine output information,
wherein the motor output information comprises information on load power output from a motor of the preceding vehicle in accordance with driving of the preceding vehicle, and
wherein the engine output information comprises information on torque and revolutions per minute (rpm), which is output from an engine of the preceding vehicle in accordance with driving of the preceding vehicle.

4. The vehicle controlling apparatus of claim 3, wherein the power profile information corresponding to the driving load information is the same as at least one of the motor output information and the engine output information of the preceding vehicle.

5. The vehicle controlling apparatus of claim 1, wherein, when the preceding vehicle information is speed information of the preceding vehicle, the controller is configured to generate power profile information based on the speed information.

6. The vehicle controlling apparatus of claim 5,
wherein the controller is configured to generate the power profile information by extracting altitude information from global positioning system (GPS) information, calculating a slope of the path by using the altitude information, calculating a speed profile of the path based on the speed information, and calculating a power profile from the slope and the speed profile, and
wherein the speed profile comprises a speed with respect to time.

7. The vehicle controlling apparatus of claim 1, further comprising a memory configured to store previous driving information,
wherein the controller is configured to generate power profile information based on the previous driving information when the preceding vehicle information is not received and is configured to generate a basic power control signal based on the power profile information.

8. The vehicle controlling apparatus of claim 1, wherein the controller is configured to generate the dynamic power control signal by defining a state of charge (SOC) of a battery corresponding to a state variable based on the power profile information and is configured to minimize a performance index and maximize energy efficiency.

9. The vehicle controlling apparatus of claim 1, wherein the communicator is configured to receive preceding vehicle information by section in response to a vehicle reaching a predetermined point of the path.

10. The vehicle controlling apparatus of claim 1,
wherein the path comprises a bus route, and
wherein, in response to a bus stopping at a bus stop of the bus route, the communicator is configured to receive preceding vehicle information of a preceding bus on a section between the bus stop at which the bus stops and a next bus stop from the preceding bus that runs along the bus route.

11. A vehicle controlling method comprising:
receiving a user input with respect to a path or a power control mode;
determining whether preceding vehicle information is received;
generating power profile information based on the received preceding vehicle information; and
generating a dynamic power control signal for driving a power source of a vehicle based on the power profile information.

12. The vehicle controlling method of claim 11, wherein, when the preceding vehicle information is driving load information of a preceding vehicle, the power profile information is power profile information corresponding to the driving load information and comprises power state information with respect to time.

13. The vehicle controlling method of claim 12,
wherein the driving load information comprises at least one of motor output information and engine output information,
wherein the motor output information comprises information on load power output from a motor of the preceding vehicle in accordance with driving of the preceding vehicle, and
wherein the engine output information comprises information on torque and rpm, which is output from an engine of the preceding vehicle in accordance with driving of the preceding vehicle.

14. The vehicle controlling method of claim 13, wherein the power profile information corresponding to the driving load information is the same as at least one of the motor output information and the engine output information of the preceding vehicle.

15. The vehicle controlling method of claim 11, wherein the generating the power profile information comprises, when the preceding vehicle information is speed information of the preceding vehicle, generating the power profile information based on the speed information.

16. The vehicle controlling method of claim 15,
wherein the generating of the power profile information comprises:
receiving GPS information;
extracting altitude information from the GPS information;
calculating a slope of the path by using the altitude information;
calculating a speed profile of the path based on the speed information; and
calculating a power profile from the slope and the speed profile,
wherein the speed profile comprises a speed with respect to time.

17. The vehicle controlling method of claim 11, further comprising:
storing previous driving information;
generating power profile information based on the previous driving information when the preceding vehicle information is not received; and
generating a basic power control signal based on the power profile information.

18. The vehicle controlling method of claim 11, wherein the generating of the dynamic power control signal comprises:
generating the dynamic power control signal by defining an SOC of a battery as a state variable based on the power profile information; and
minimizing a performance index to maximize energy efficiency.

19. The vehicle controlling method of claim 11, wherein the determining whether the preceding vehicle information is received comprises determining whether preceding vehicle information by section is received in response to a vehicle reaching a predetermined point of the path.

20. The vehicle controlling method of claim 11,
wherein the path comprises a bus route, and
wherein, the determining whether the preceding vehicle information is received comprises in response to a bus stopping at a bus stop of the bus route, receiving from a preceding bus which runs along the bus route preceding vehicle information of the preceding bus on a section between the bus stop at which the bus stops and a next bus stop.
